(19) United States
(12) Patent Application Publication
(10) Pub. No.: US 2015/0364286 A1
(43) Pub. Date: Dec. 17, 2015

(54) COMPLEX PROTECTION DEVICE

(71) Applicant: SMART ELECTRONICS INC., Ulsan (KR)

(72) Inventors: Doo Won KANG, Anyang-si (KR); Hyun Chang KIM, Ulsan (KR); Kwang Beom KIM, Yangsan-si (KR); Saeng Soo YUN, Busan (KR); Hyuk Jae KWON, Busan (KR)

(21) Appl. No.: 14/733,381

(22) Filed: Jun. 8, 2015

(30) Foreign Application Priority Data
Jun. 13, 2014 (KR) 10-2014-0072029
Jun. 13, 2014 (KR) 10-2014-0072032
Oct. 1, 2014 (KR) 10-2014-0132443

(51) Int. Cl. H01H 83/20; H01H 61/013; H01H 37/32

(52) U.S. Cl. CPC H01H 83/20; H01H 37/32; H01H 61/013; H01H 2037/326

(57) ABSTRACT

Provided is a complex protection device which can protect a circuit and circuit elements installed at the circuit against overcurrent and overvoltage. Heat is generated from thin film type printed resistors installed at opposite sides of a fusible element or directly beneath the fusible element and, as such, it is possible to improve thermal characteristics of the product, to design an ultraminiature product, and to simplify manufacture processes.

### BACKGROUND OF THE INVENTION

1. Field of the Invention

The present invention relates to a complex protection device, and more particularly to a complex protection device capable of protecting a circuit and circuit elements installed at the circuit from overcurrent and overvoltage, achieving an improvement in thermal characteristics by virtue of heat generation at thin film type printed resistors installed at opposite sides of a fusible element or directly under the fusible element, achieving design of a ultraminiature product, and simplifying manufacture processes.

2. Description of the Related Art

A non-recovery type protection device, which responds to overheating generated due to overcurrent flowing through an appliance to be protected or ambient temperature, operates at a certain operating temperature, to break an electric circuit of the appliance so as to achieve safety of the appliance. For example, there is a protection device, which causes a resistor to generate heat in response to a signal current generated in accordance with sensing of abnormality occurring in an appliance, and operates a fuse element by the generated heat.

Korean Patent Unexamined Publication No. 10-2001-0006916 discloses a protection device in which an electrode for a low melting-point metal element and a heating element are formed on a substrate, a low melting-point metal element is directly formed on the heating element, an inner seal made of solid flux or the like is formed over the low melting-point metal element in order to prevent surface oxidation of the low melting-point metal element, and an outer seal or cap is formed outside the inner seal in order to prevent a melt from flowing outwards of the device when the low melting-point metal element is melted.

Meanwhile, Korean Registered Patent No. 10-1388354 discloses a complex protection device which includes a fusible element connected to first and second terminals of a main circuit, to be melted when overcurrent flows through the main circuit, a resistor connected to a resistor terminal connected to the fusible element, and a switching element to perform a control operation to cause current to flow to the resistor terminal when a voltage exceeding a reference voltage is applied. In the complex protection device, the first and second terminals and resistor terminals are arranged on the same plane while being spaced apart from each other, and the fusible element is melted by heat generated from a resistor when a voltage exceeding the reference voltage is applied to the resistor.

The resistor disclosed in the registered patent, which is of a chip type, has drawbacks in that installation costs and manufacturing costs are high, as compared to a printed resistor. Furthermore, when the fusible element is melted in accordance with heat generation of the resistor, melting of the fusible element may occur under the condition that the central region of the fusible element contracts insufficiently or is incompletely spaced from a shearing region or a rear end region, it may be impossible to cut off flow of current and, as such, a circuit to be protected by the protection device or circuit elements installed at the circuit may not be protected.

Accordingly, it is necessary to develop a complex protection device having a structure capable of efficiently achieving contraction of the central region when the fusible element is melted, thereby securely cutting off flow of current.

### SUMMARY OF THE INVENTION

Therefore, the present invention has been made in view of the above problems, and it is an object of the present invention to provide a complex protection device in which a thin film type printed resistor is directly printed on a substrate, thereby being capable of automating manufacture and achieving reduction of manufacturing costs and design of an ultraminiature structure, as compared to a protection device with a chip type resistor.

It is another object of the present invention to provide a complex protection device in which printed resistors installed at opposite sides of a fusible element and directly under the fusible element generate heat, thereby being capable of achieving an improvement in thermal characteristics.

It is a further object of the present invention to provide a complex protection device in which at least two printed resistors generate heat in such a manner that the total amount of heat is divided among the resistors, thereby being capable of achieving an enhancement in durability and, as such, the protection device is applicable even to a high-capacity product.

It is a still further object of the present invention to provide a complex protection device in which contraction of a fusible element is induced by a circular or oval fuse terminal, thereby being capable of achieving an enhancement in melting and contraction efficiency.

In accordance with the present invention, the above and other objects can be accomplished by the provision of a complex protection device including a substrate provided, at an upper surface thereof, with a pair of fuse terminals, first and second resistor terminals, and first and second connecting terminals to connect the first and second resistor terminals, an insulating layer formed on the first and second connecting terminals, a fusible element formed on the insulating layer, to be connected to the fuse terminals, first and second printed resistors respectively connected to the first and second resistor terminals, and a switching device for performing a control operation to cause current to flow to the first and second resistors when overvoltage is applied, wherein the first and second printed resistors are disposed at opposite sides of the fusible element while being spaced apart from the fusible element.

The complex protection device may further include third resistor terminals provided at a lower surface of the substrate, and a third printed resistor connected to the third resistor terminals and disposed directly under the fusible element under a condition that the substrate is interposed between the third printed resistor and the fusible element.

One of the first and second connecting terminals may be provided with a contact portion to contact the fusible element. One side of the contact portion may be disposed directly under a central region of the fusible element. Current emerging from the fusible element may flow to the first and second printed resistors via the contact portion in a divided manner. Heat generated from the first and second printed resistors may be transferred to the fusible element via the contact portion.

The complex protection device may further include a third connecting terminal disposed between the first and second connecting terminals. The third connecting terminal may have a free end connectable to the fusible element and a fixed end connected to one of the first and second resistor terminals. The free end of the third connecting terminal may be disposed directly under a central region of the fusible element. Current emerging from the fusible element may flow to the first, second and third printed resistors via the third connecting terminal in a divided manner. Heat generated from the first, second and third printed resistors may be transferred to the fusible element via the third connecting terminal.

Facing surfaces of the fuse terminals may have a semicircular or semi-oval shape.

The fusible element may include a plate-shaped alloy portion, and a flux portion received in the alloy portion.

A protective film made of an insulating material may be formed over the first, second, and third printed resistors.

A resistor receiving groove may be formed at the lower surface of the substrate, to receive the third resistor terminals and the third printed resistor, for installation thereof.

A protective film may be formed on the third printed resistor received in the resistor receiving groove, to bury the third printed resistor in the substrate.

A heat transfer hole may be formed directly under the fusible element, to easily transfer heat generated from the third printed resistor to the fusible element.

Each of the third resistor terminals may be connected to a corresponding one of the first and second connecting terminals through a via hole provided directly under the fusible element.

The complex protection device may further include a melting inducing member disposed directly under the central region of the fusible element, to concentrate heat to the fusible element during heat generation of the resistors. The melting inducing member may have a circular or oval shape, to allow a melt of the fusible element to contract toward a center of the melting inducing member during melting of the fusible element.

A contact portion may be provided at one of the first and second connecting terminals directly under the melting inducing member. An insulating layer may be formed between the melting inducing member and the first and second connecting terminals while centrally having a hole to connect the melting inducing member and the contact portion through soldering.

One of the first and second connecting terminals may include the contact portion, and a pair of connecting portions each connected, at one end thereof, to the contact portion while being connected, at the other end thereof, to a corresponding one of the first and second resistor terminals. The contact portion may have a circular or oval shape while having a greater width than the connecting portions. An insulating layer may be formed between the contact portion and the fusible element while centrally having a hole to connect the contact portion and the fusible element through soldering.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram explaining a use state of a complex protection device according to the present invention;

FIGS. 2A and 2B are plan and bottom views illustrating a first embodiment of the complex protection device according to the present invention;

FIGS. 3A and 3B are perspective and exploded perspective views illustrating the first embodiment of the complex protection device according to the present invention;

FIGS. 4A and 4B are cross-sectional views taken along lines A-A and B-B of FIG. 2A, respectively;

FIG. 4C is a sectional view of a fusible element according to the present invention;

FIG. 5 is a circuit diagram illustrating melting of the fusible element when overcurrent is applied to a main circuit;

FIGS. 6 and 7 are a circuit diagram and a plan view, which illustrate melting of the fusible element when overvoltage is applied to the main circuit;

FIG. 8 is a longitudinal-sectional view illustrating a resistor receiving groove formed at a lower surface of a substrate;

FIG. 9 is an exploded perspective view corresponding to FIG. 3B, to illustrate a second embodiment of the complex protection device according to the present invention in which a third connecting terminal is formed;

FIGS. 10A and 10B are perspective and exploded perspective views corresponding to FIGS. 3A and 3B, to illustrate a third embodiment of the complex protection device according to the present invention;

FIGS. 11A and 11B are cross-sectional views corresponding to FIGS. 4A and 4B taken along lines A-A and B-B of FIG. 2A, respectively;

FIGS. 12A and 12B are perspective and exploded perspective views corresponding to FIGS. 3A and 3B, to illustrate a fourth embodiment of the complex protection device according to the present invention; and

FIGS. 13A and 13B are cross-sectional views corresponding to FIGS. 4A and 4B taken along lines A-A and B-B of FIG. 2A, respectively;

### DETAILED DESCRIPTION OF THE INVENTION

Reference will now be made in detail to the preferred embodiments of the present invention, examples of which are illustrated in the accompanying drawings.

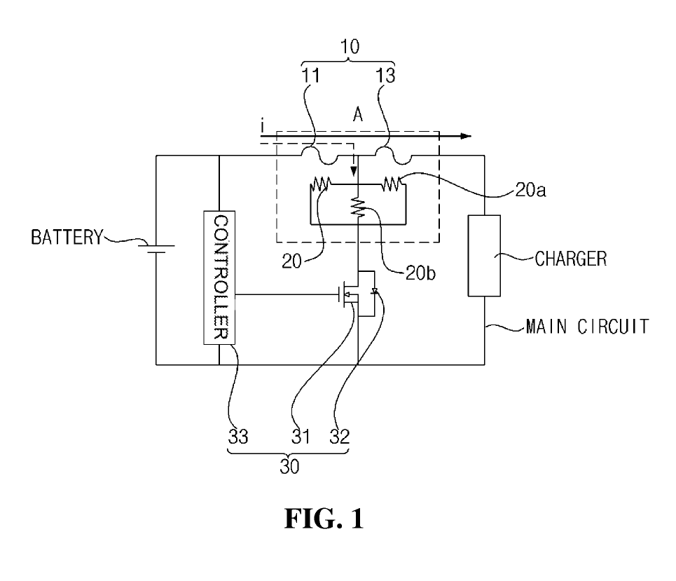

Referring to FIG. 1, a complex protection device according to the present invention is illustrated. The complex protection device functions to protect a circuit and elements connected to a main circuit in an abnormal state through melting of a fusible element 10 connected to the main circuit.

The main circuit, to which the complex protection device according to the embodiment of the present invention is applied, has no particular limitation as to the kind thereof. The main circuit may be a charging circuit to charge a battery.

On the main circuit, a battery and a charger are connected to the fusible element 10. In detail, the main circuit may include a plurality of resistors 20, 20a, and 20b, and a switching device 30 connected to the resistors 20, 20a, and 20b.

The switching device 30 may be illustrated as including a transistor 31, a diode 32, and a controller 33 for applying a control signal to turn on the transistor 31 when overvoltage is applied, thereby controlling current to flow through the resistors 20, 20a, and 20b.

First, when overcurrent is applied to the main circuit, the fusible element 10 is melted by heat generated due to the applied overcurrent and, as such, protects the circuit and circuit elements.

Next, when overvoltage is applied to the main circuit, the fusible element 10 is melted by heat generated from the resistors 20 and 20a and, as such, protects the circuit and circuit elements.

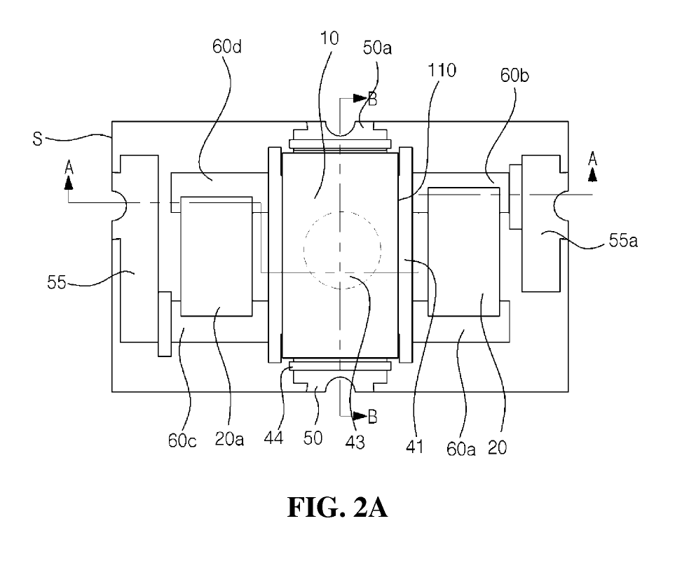

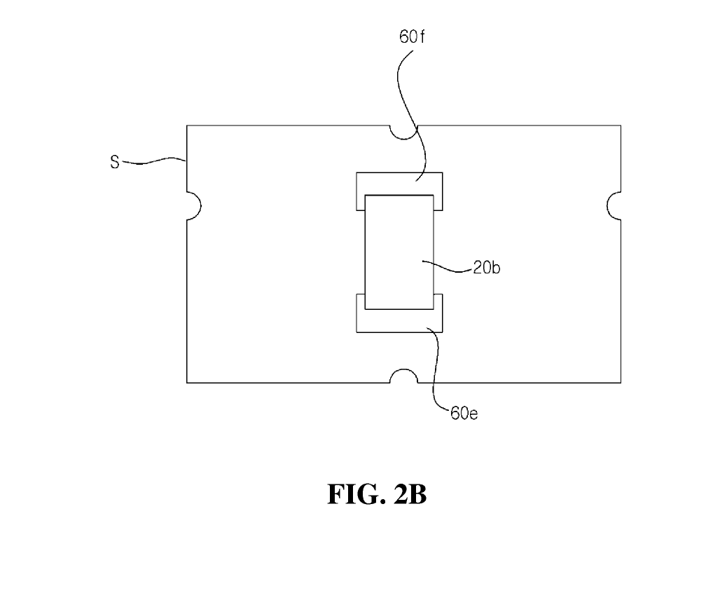

Referring to FIGS. 2A to 4B, a complex protection device according to a first embodiment of the present invention includes a substrate S. The fusible element 10 and the first, second and third resistors 20, 20a and 20b, which are of a printed type, are installed at the substrate S.

Formed on an upper surface of the substrate S are fuse terminals 50 and 50a, to which the fusible element 10 is connected, first resistor terminals 60a and 60b, to which the first printed resistor 20 is connected, second resistor terminals 60c and 60d, to which the second printed resistor 20a is connected, and first and second connecting terminals 70 and 70a to connect the first and second resistor terminals 60a, 60b, 60c, and 60d, and terminals 55 and 55a.

Third resistor terminals 60e and 60f, to which the third printed resistor 20b is connected, are provided at a lower surface of the substrate S. A pair of via holes 61 may be provided at the substrate S, to vertically connect the third resistor terminals 60e and 60f to the first and second connecting terminals 70 and 70a, respectively. Although not shown, the third resistor terminals 60e and 60f may be connected to the first and second connecting terminals 70 and 70a through circuit patterns formed at the upper, side and lower surfaces of the substrate S, in place of the via holes.

Terminal holes H are formed at opposite lateral ends of the substrate S, to electrically connect the complex protection device to the main circuit.

The first connecting terminal 70 electrically connects the first resistor terminal 60a and the second resistor terminal 60c.

The second connecting terminal 70a may include a contact portion 71 centrally disposed to contact the fusible element 10, and a pair of connecting portions 73 extending from opposite sides of the contact portion 71, to connect the first resistor terminal 60b and the second resistor terminal 60d.

The contact portion 71 is disposed directly under the fusible element 10 and, as such, transfers a portion of heat generated from the resistors 20 and 20a to the fusible element 10.

An insulating layer 41 is disposed between the first and second connecting terminals 70 and 70a and the fusible element 10, to electrically isolate the fusible element 10 from the first and second connecting terminals 70 and 70a.

The insulating layer 41 includes a plate-shaped insulating portion 42, and a hole 43 centrally formed through the insulating portion 42.

The insulating portion 42 prevents the fusible element 10 from being connected to the connecting terminals 70 and 70a. A solder 43a fills the hole 43, to electrically connect the contact portion 71 to the fusible element 10.

In this case, opposite ends 42a and 42b of the insulating portion 42 may have a circular or oval shape corresponding to those of ends 50′ and 50a′ of the fuse terminals 50 and 50a.

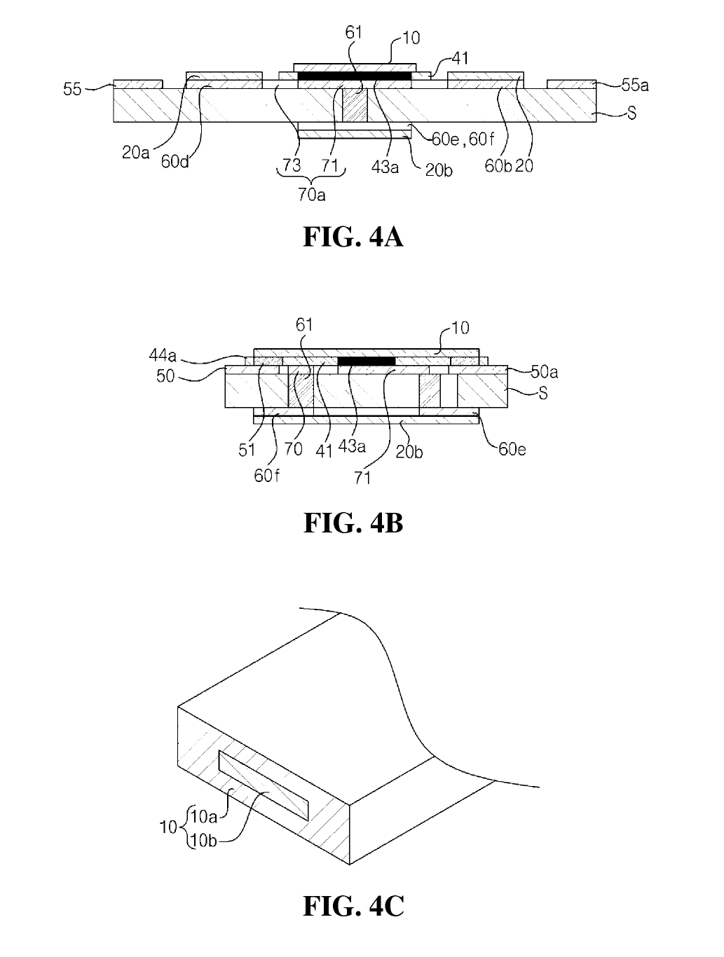

Referring to FIG. 4C, the fusible element 10 is illustrated as including a plate-shaped alloy portion 10a, and a flux portion 10b received in the alloy portion 10a.

The alloy portion 10a is made of a tin or tin alloy having a melting point of 120 to 300° C. When heated, the alloy portion 10a is melted to break electrical connection.

The flux portion 10b functions to contract the melted alloy portion 10a. For example, the flux portion 10b may be made of chloride, fluoride, resin, or the like.

The fusible element 10 is preferably connected to the fuse terminals 50 and 50a under the condition that the fusible element 10 is layered on the insulating layer 41. In addition, contact members 51 are preferably formed between the fusible element 10 and the fuse terminals 50 and 50a, to eliminate steps formed between the fusible element 10 and the fuse terminals 50 and 50a, respectively.

The first resistor terminals 60a and 60b and the second resistor terminals 60c and 60d are arranged at opposite sides of the associated fuse terminals 50 and 50a, respectively. The first and second printed resistors 20 and 20a generate heat at opposite sides of the fusible element 10, respectively.

The third resistor terminals 60e and 60f are disposed directly under the fuse terminals 50 and 50a, respectively, under the condition that the substrate S is interposed therebetween. The third printed resistor 20b generates heat under the fusible element 10.

Thus, in accordance with the illustrated embodiment of the present invention, it may be possible to achieve division of resistance or amount of heat by disposing the first and second printed resistors 20 and 20a at opposite lateral sides of the fusible element 10, and disposing the third printed resistor 20b directly under the fusible element 10 under the condition that the substrate S is interposed therebetween.

In addition, the first, second, and third printed resistors 20, 20a, and 20b have thin film structures and, as such, are directly printed on the substrate without using lead wires. Accordingly, an automation process may be easily applied to manufacture of the printed resistors 20, 20a, and 20b. Moreover, it may be possible to miniaturize the printed resistors 20, 20a, and 20b and to reduce manufacturing costs, as compared to surface-mounted resistors.

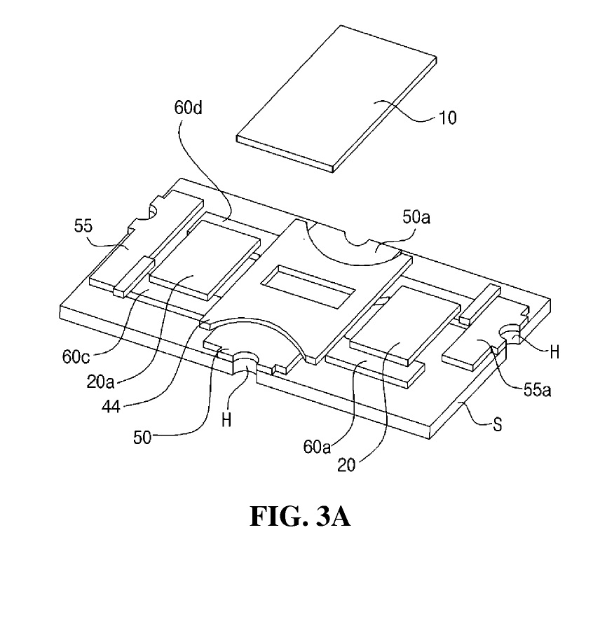

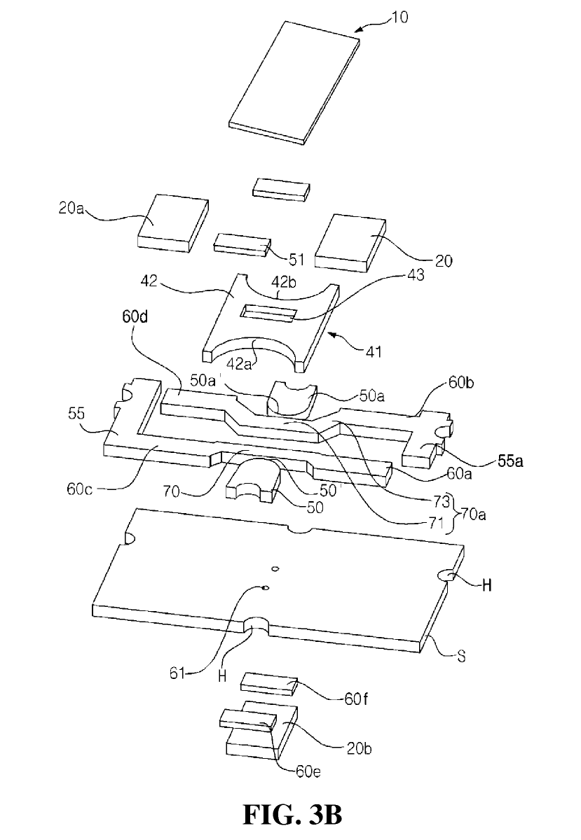

Referring to FIGS. 3B and 4A, current applied to the fusible element 10 flows through the contact portion 71, then flows from the contact portion 71 to the first resistor terminals 60a and 60b, the second resistor terminals 60c and 60d, and the third resistor terminals 60e and 60f via the connecting portions 73 in a divided manner, and finally flows to the terminal 55 in a joined manner.

The first and second printed resistors 20 and 20a generate heat at opposite sides of the fusible element 10. The generated heat heats the fusible element 10 in the form of radiant heat and conductive heat through the contact portion 71 and, as such, the fusible element 10 is melted.

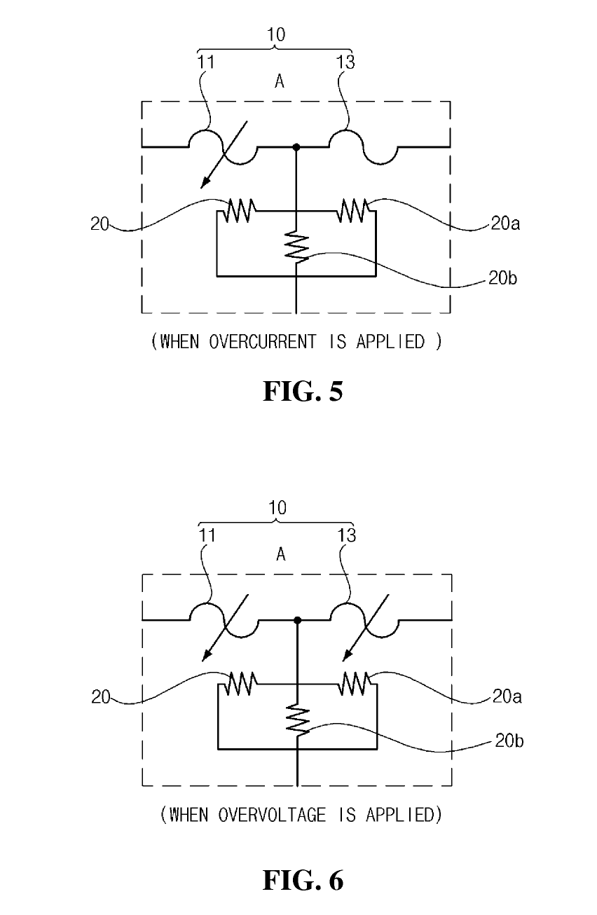

Referring to FIGS. 1 and 5, the fusible element 10 is melted in accordance with heating thereof occurring when surge current is momentarily applied to the main circuit or overcurrent is continuously applied to the main circuit.

In this case, melting of the fusible element 10 is generated at a front portion 11 of the fusible element 10. Due to melting of the fusible element 10, flow of current through the main circuit is prevented and, as such, damage or explosion of the circuit and circuit elements is prevented.

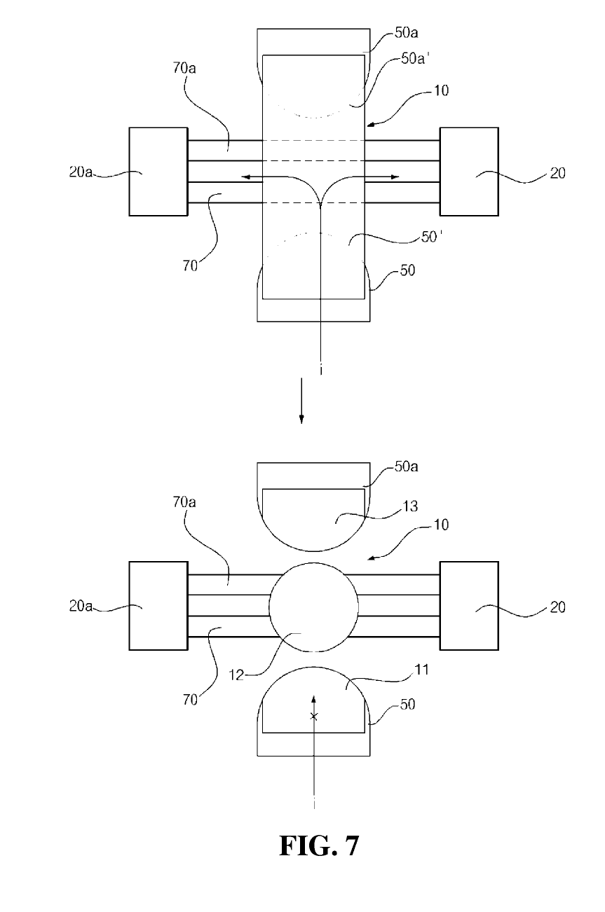

Referring to FIGS. 1, 6, and 7, when overvoltage exceeding a reference voltage is applied to the main circuit, the switching device 30 performs a control operation to allow current to flow through the first, second, and third resistors 20, 20a, and 20b.

The fusible element 10 includes a middle portion 12 contacting the contact portion 71, and front and rear portions and 13 extending forwards and rearwards from the middle portion 12. At least one of the front and rear portions 11 and is melted by heat generated due to introduction of current into the first, second, and third printed resistors 20, 20a, and 20b and, as such, the fusible element 10 protects the circuit.

That is, when the fusible element 10 is melted due to heat generated at the first, second, and third printed resistors 20, 20a, and 20b, the melt of the fusible element 10 contracts by virtue of surface tension thereof exhibited on the corresponding fuse terminal, at least two of the front portion 11, middle portion 12, and rear portion 13 are separated from each other.

Accordingly, the end 50′ of the fuse terminal 50 close to the front end 11 of the fusible element 10 and the end 50a′ of the fuse terminal 50a close to the rear end 13 of the fusible element 10 preferably have a semicircular or semi-oval shape. When the ends 50′ and 50a′ of the fuse terminals 50 and 50a have a semicircular or semi-oval shape, melt of the front portion 11 or rear portion 13 exhibits uniform molecular force toward the center of the corresponding fuse terminal 50 or 50a and, as such, exhibits increased contractive force, thereby causing the front portion 11 or rear portion 13 to be reliably separated from the middle portion 12.

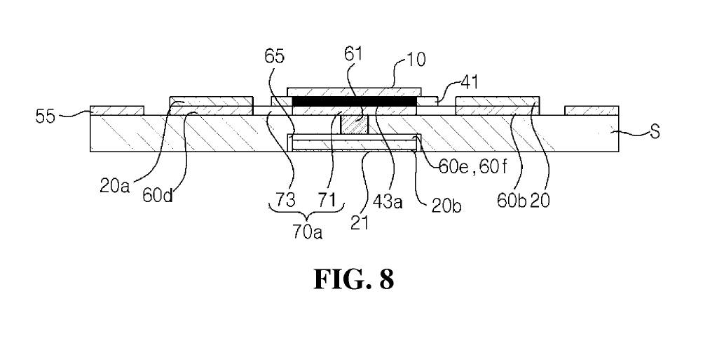

Referring to FIG. 8, a resistor receiving groove 65 may be formed at a lower surface of the substrate S.

The third resistor terminals 60e and 60f and third printed resistor 20b are installed at the resistor receiving groove 65 and, as such, it may be possible to reduce the total thickness of the complex protection device.

Meanwhile, as illustrated in FIG. 8, a protective film 21, which is made of an insulating material exhibiting high resistance against moisture, for example, a polymer, is preferably formed over the surface of the third printed resistor 20b. Such a printed resistor is oxidized when exposed to moisture and, as such, may not perform desired functions thereof and may be reduced in lifespan. When the printed resistor is shielded by a protective film, such problems may be solved. Of course, similarly to the third printed resistor 20b, the first and second printed resistors 20 and 20a may be formed with a protective film.

Thus, in this embodiment, there are advantages in that it may be possible to achieve miniaturization of the product and to enhance melting and contraction efficiency of the fusible element because printed resistors are disposed at the upper and lower surfaces of the substrate S, respectively.

Hereinafter, a second embodiment of the present invention will be described with reference to the accompanying drawings.

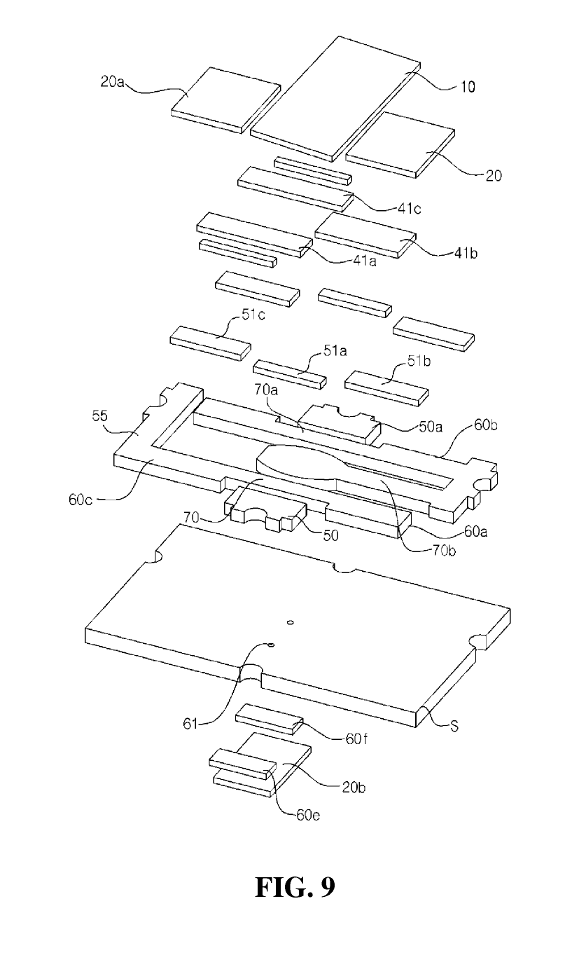

Referring to FIG. 9, in accordance with this embodiment, the first and second printed resistors 20 and 20a are disposed at opposite sides of the substrate S on the upper surface of the substrate S, and the third printed resistor 20b is disposed on the lower surface of the substrate S, as in the first embodiment.

However, this embodiment differs from the first embodiment in that a third connecting terminal 70b is disposed between the first and second connecting terminals 70 and 70a, in place of the contact portion 71 in the first embodiment, and the insulating layer is divided into first, second, and third insulating portions 41a, 41b, and 41c.

The third connecting terminal 70b has a free end connectable to the fusible element 10 at one end thereof while having a fixed end connected to the first resistor terminal 60b at the other end thereof.

The free end of the third connecting terminal 70b has an oval shape and is disposed directly under the fusible element 10 and, as such, not only functions to connect the fusible element 10 and the resistors, but also to induce melting of the fusible element 10.

Heat generated from the first, second, and third printed resistors 20, 20a, and 20b is transferred to the fusible element 10 via the third connecting terminal 70b.

Current applied to the fusible element 10 flows to the first resistor terminals 60a and 60b, the second resistor terminals 60c and 60d, and the third resistor terminals 60e and 60f via the third connecting terminal 70b in a divided manner, and then flows to the terminal 55 in a joined manner.

Thus, in the second embodiment of the present invention, it may be possible to design various structures of the connecting terminals and insulating layer. In addition, it may be possible to efficiently induce melting and contraction of the fusible element 10 by disposing the third connecting terminal directly under the fusible element 10.

Hereinafter, a third embodiment of the present invention will be described with reference to the accompanying drawings.

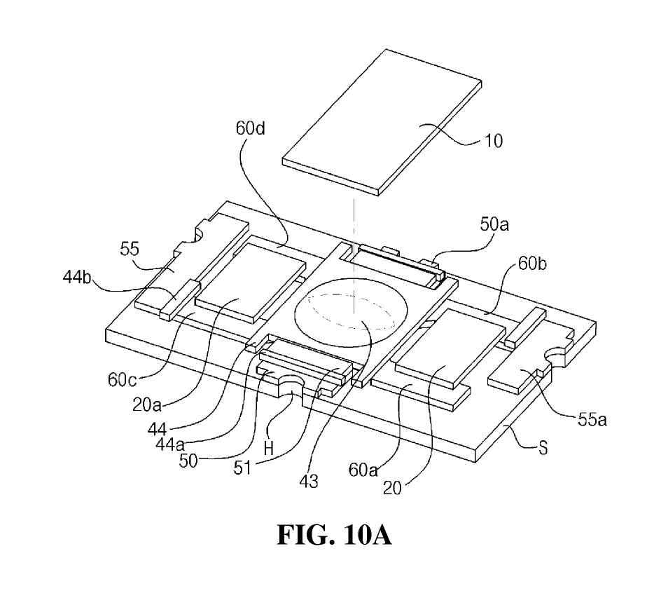

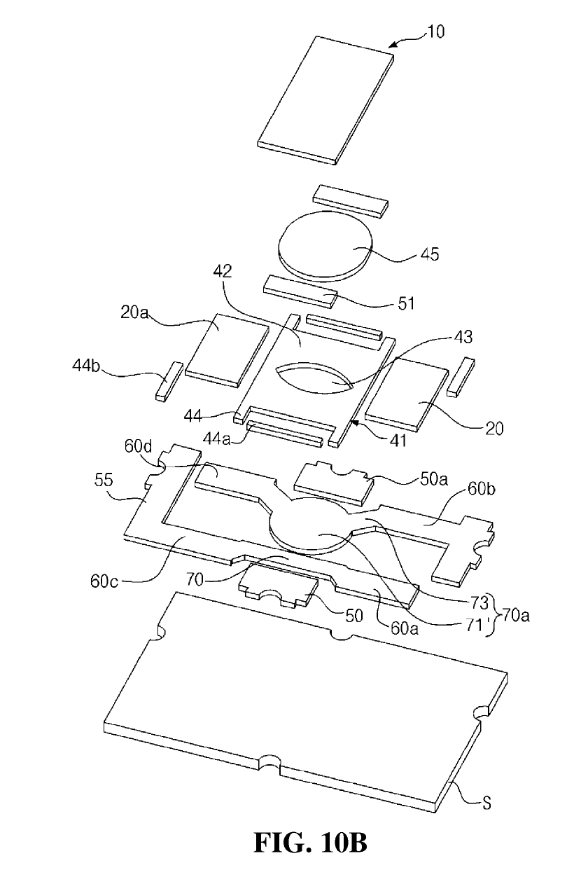

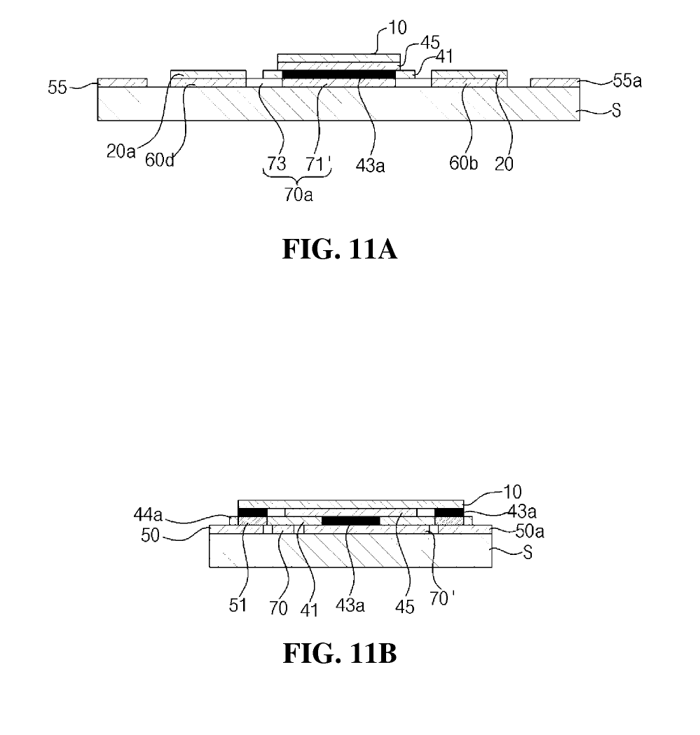

Referring to FIGS. 10A to 11B, the complex protection device of this embodiment includes the substrate S. The fusible element 10 and the first and second printed resistors 20 and 20a are installed at the substrate S.

Formed on the substrate S are fuse terminals 50 and 50a, to which the fusible element 10 is connected, first resistor terminals 60a and 60b, to which the first printed resistor 20 is connected, second resistor terminals 60c and 60d, to which the second printed resistor 20a is connected, and first and second connecting terminals 70 and 70a to connect the first and second resistor terminals 60a, 60b, 60c, and 60d, terminals 55 and 55a, and terminal holes H. The insulating layer 41, a melting inducing member 45, and the fusible element 10 are sequentially layered on the first and second connecting terminals 70 and 70a. The terminal holes H function to electrically connect the main circuit and the complex protection device.

Contact members 51 are preferably formed on the fuse terminals 50 and 50a. Since the fusible element 10 is disposed on the insulating layer 41 and the melting inducing member 45, steps are formed between the fusible element 10 and the fuse terminals 50 and 50a. In accordance with provision of the contact members 51 on the fuse terminals 50 and 50a, the fusible element 10 may be in contact with the fuse terminals 50 and 50a on the same plane.

The fuse terminals 50 and 50a, the first and second terminals 60a and 60b, and the second resistor terminals 60c and 60d are arranged on the same plane while being spaced apart from one another.

The first connecting terminal 70 functions to electrically connect the first resistor terminal 60a and the second resistor terminal 60c.

The second connecting terminal 70a may include a contact portion 71′ centrally disposed to connect the fusible element 10 and the resistors while having a circular or oval shape, and a pair of connecting portions 73 extending from opposite sides of the contact portion 71′, to connect the first resistor terminal 60b and the second resistor terminal 60d.

The contact portion 71′ is disposed directly under the melting inducing member 45 and, as such, transfers a portion of heat generated from the resistors 20 and 20a to the fusible element 10.

The connecting portions 73 have structures bent from the resistor terminals 60b and 60d toward the contact portion 71′, to allow the fuse terminal 50a to be disposed in a space between the two connecting portions 73, and, as such, may contribute to miniaturization. That is, the first connecting terminal 70 and second connecting terminal 70a are disposed between the fuse terminals 50 and 50a, and the pair of connecting portions 73 are disposed while being bent from the resistor terminals 60b and 60d in a central direction, respectively, and, as such, the spacing between the fuse terminals is reduced to achieve miniaturization. Since the contact portion 71′ is provided to be disposed directly under the melting inducing member 45 while having a shape and an area, which correspond to those of the melting inducing member 45, it may be possible to effectively transfer heat from the resistors to the melting inducing member 45.

The first and second printed resistors 20 and 20a function to generate heat upon application of overvoltage, thereby melting the fusible element 10. To this end, the first and second printed resistors 20 and 20a are preferably disposed at opposite sides of the fusible element 10.

The insulating layer 41, melting inducing member 45, and fusible element 10 are sequentially layered on the first and second connecting terminals 70 and 70a.

The insulating layer 41 may include a plate-shaped insulating portion 42, and first barrier films 44.

The insulating portion 42 functions to prevent the fusible element 10 from being connected to the connecting terminals 70 and 70a. The insulating portion 42 is formed with a hole 43 to allow the melting inducing member 45 and contact portion 71′ to be connected through soldering.

The hole 43 is arranged directly under the melting inducing member 45 while having a circular or oval shape. A solder 43a fills the hole 43, to electrically connect the melting inducing member 45 and contact portion 71′.

Each first barrier film 44 prevents the solder melted upon soldering of the fusible element 10 from flowing laterally. Respective pairs of first barrier films may be formed at opposite sides of the insulating portion 42 on front and rear ends of the insulating portion 42, respectively.

Similarly to the first barrier film 44, a pair of second barrier films 44a may be formed on the fuse terminals, respectively, to prevent the solder 43a melted during soldering of the fusible element 10 from moving.

When the solder 43a coated over the fuse terminal 50 moves after being melted during soldering of the fusible element 10, the fusible element 10 laid on the solder 43a moves together with the solder 43a and, as such, defects may be generated. To this end, the first and second barrier films 44 and 44a are installed around the fusible element 10, to prevent movement of the solder 43a and to retain the fusible element 10 at a desired position. In addition, although not shown, the levels of the first and second harrier films 44 and 44a are higher than the lower surface of the fusible element 10 and, as such, it may be possible to retain the fusible element 10 irrespective of movement of the solder 43a.

Meanwhile, the melting inducing member 45 preferable has a circular or oval shape to effectively induce melting and contraction of the fusible element 10 and, as such, melting and contraction may be efficiently achieved.

In detail, the melting inducing member 45 is disposed between the fusible element 10 and the contact portion 71′, not only to electrically connect the fusible element 10 and the contact portion 71′, but also to transfer heat transferred through the contact portion 71′ to the fusible element 10. The melting inducing member 45 may have a length (diameter) corresponding to the width of the fusible element 10.

The fusible element 10 is connected to the fuse terminals and 50a. When overcurrent is applied to the main circuit, the fusible element 10 is melted, thereby protecting the circuit and circuit elements.

Current applied to the fusible element 10 flows through the contact portion 71′ via the melting inducing member 45, then flows from the contact portion 71′ to the first resistor terminals 60a and 60b and the second resistor terminals 60c and 60d in a divided manner, and finally flows to the terminal 55 in a joined manner.

The first and second printed resistors 20 and 20a generate heat at opposite sides of the fusible element 10. The generated heat not only heats the fusible element 10 in the form of radiant heat, but also heats the fusible element 10 in the form of conductive heat through the contact portion 71′ and melting inducing member 45 and, as such, the fusible element 10 is melted.

Thus, in the third embodiment of the present invention, it may be possible to efficiently achieve melting and contraction of the fusible element 10 by disposing the circular or oval melting inducing member 45 directly under the fusible element 10.

Hereinafter, a fourth embodiment of the present invention will be described with reference to the accompanying drawings.

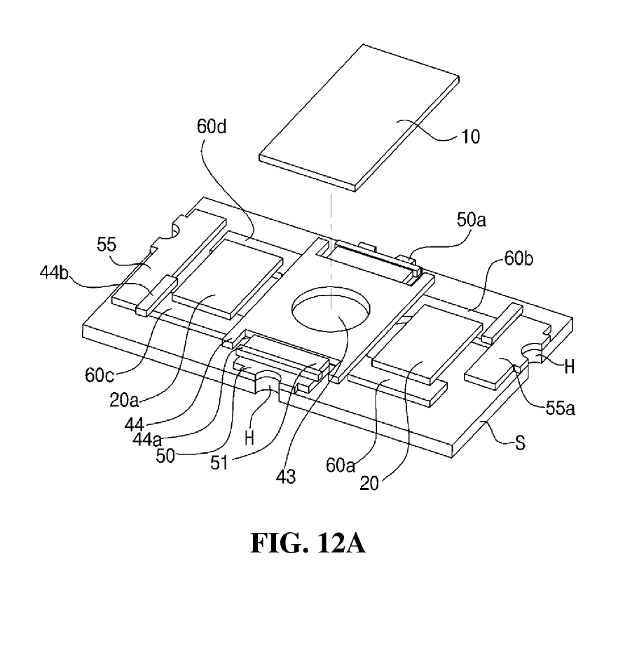

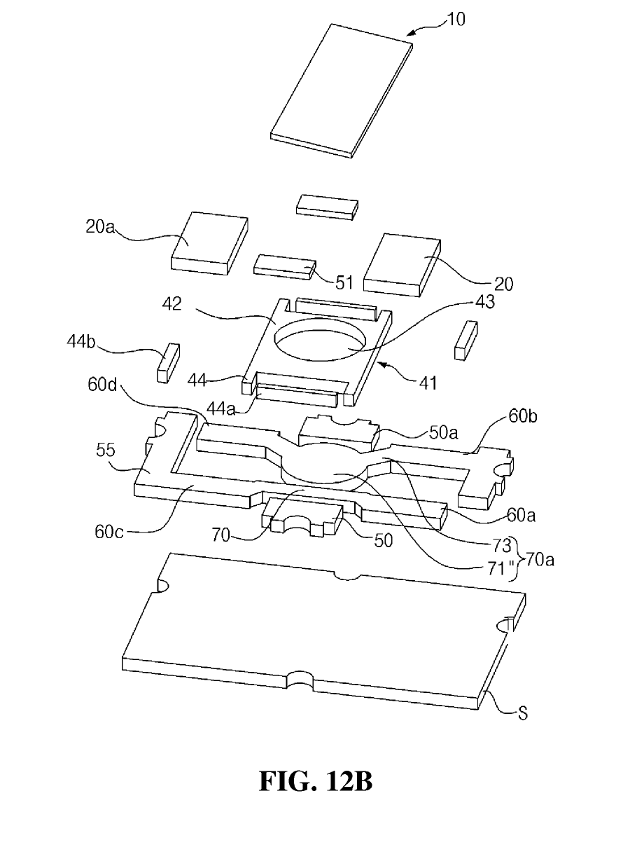

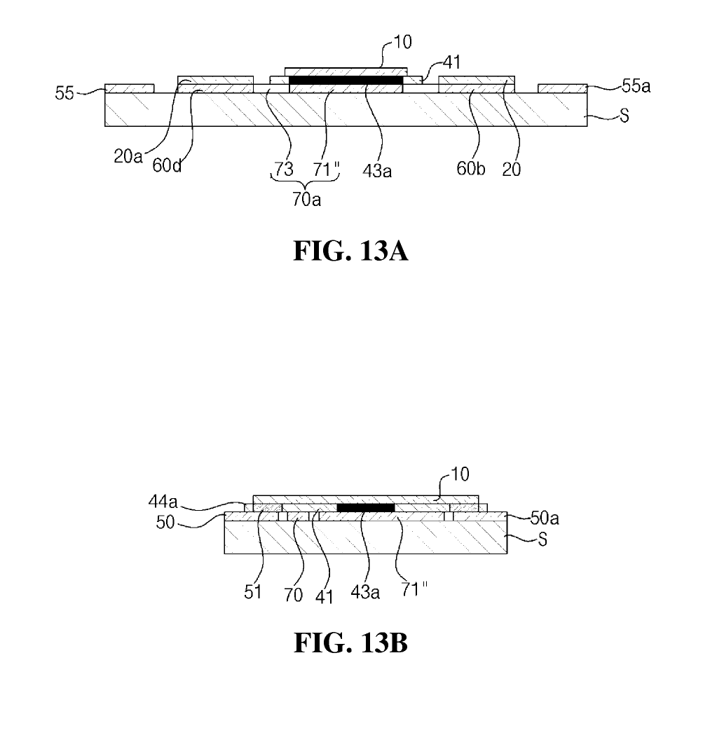

Referring to FIGS. 12A and 13B, the complex protection device of this embodiment includes the substrate S. The fusible element 10 and the first and second printed resistors 20 and 20a are installed at the substrate S.

Formed on the substrate S are fuse terminals 50 and 50a, to which the fusible element 10 is connected, first resistor terminals 60a and 60b, to which the first printed resistor 20 is connected, second resistor terminals 60c and 60d, to which the second printed resistor 20a is connected, and first and second connecting terminals 70 and 70a to connect the first and second resistor terminals 60a, 60b, 60c, and 60d, terminals 55 and 55a, and terminal holes H. The insulating layer 41 and the fusible element 10 are sequentially layered on the first and second connecting terminals 70 and 70a. The terminal holes H function to electrically connect the main circuit and the complex protection device.

Contact members 51 are preferably formed on the fuse terminals 50 and 50a.

The fuse terminals 50 and 50a, the first and second terminals 60a and 60b, and the second resistor terminals 60c and 60d are arranged on the same plane while being spaced.

The first connecting terminal 70 functions to electrically connect the first resistor terminal 60a and the second resistor terminal 60c.

The second connecting terminal 70a may include a contact portion 71″ centrally disposed while having a circular or oval shape, and a pair of connecting portions 73 extending from opposite sides of the contact portion 71″, to connect the first resistor terminal 60b and the second resistor terminal 60d.

The contact portion 71″ is disposed directly under the middle portion 12 of the fusible element 10 and a hole 43, which will be described later. The contact portion 71″ not only functions to transfer a portion of heat generated from the resistors 20 and 20a, but also to induce melting and contraction of the fusible element 10. In order to efficiently achieve melting and contraction, the contact portion 71″ preferably has a circular or oval shape.

The connecting portions 73 have structures bent from the resistor terminals 60b and 60d toward the contact portion 71″, to allow the fuse terminal 50a to be disposed in a space between the two connecting portions 73. That is, the first connecting terminal 70 and second connecting terminal 70a are disposed between the fuse terminals 50 and 50a, and the pair of connecting portions 73 are disposed while being bent from the resistor terminals 60b and 60d in a central direction, respectively, and, as such, the spacing between the fuse terminals is reduced to achieve miniaturization of the product.

The first and second printed resistors 20 and 20a function to generate heat upon application of overvoltage, thereby melting the fusible element 10. To this end, the first and second printed resistors 20 and 20a are preferably disposed at opposite sides of the fusible element 10.

The insulating layer 41 and fusible element 10 are sequentially layered on the first and second connecting terminals 70 and 70a.

The insulating layer 41 may include a plate-shaped insulating portion 42, and first barrier films 44.

The insulating portion 42 functions to prevent the fusible element 10 from being connected to the connecting terminals 70 and 70a. The insulating portion 42 is formed with the hole 43 to allow the fusible element 10 and contact portion 71″ to be connected through soldering.

Current applied to the fusible element 10 flows through the contact portion 71″, then flows from the contact portion 71″ to the first resistor terminals 60a and 60b and the second resistor terminals 60c and 60d via the connecting portions 73 in a divided manner, and finally flows to the terminal 55 in a joined manner.

The first and second printed resistors 20 and 20a generate heat at opposite sides of the fusible element 10. The generated heat not only heats the fusible element 10 in the form of radiant heat, but also heats the fusible element 10 in the form of conductive heat through the contact portion 71″ and, as such, the fusible element 10 is melted.

Thus, in the fourth embodiment, it may be possible to induce melting and contraction of the fusible element 10 by configuring the separate contact portion 71″ to have a circular or oval shape.

As apparent from the above description, in accordance with the complex protection device of the present invention, a thin film type printed resistor is directly printed on a substrate and, as such, it may be possible to automate manufacture and to achieve reduction of manufacturing costs and design of an ultraminiature structure, as compared to a protection device with a chip type resistor.

In addition, in accordance with the complex protection device of the present invention, printed resistors installed at opposite sides of a fusible element and directly under the fusible element generate heat and, as such, it may be possible to achieve an improvement in thermal characteristics.

Furthermore, in accordance with the complex protection device of the present invention, at least two printed resistors generate heat in such a manner that the total amount of heat is divided among the resistors and, as such, it may be possible to achieve an enhancement in durability. Accordingly, the protection device is applicable even to a high-capacity product.

In addition, in accordance with the complex protection device of the present invention, contraction of a fusible element is induced by a circular or oval fuse terminal and, as such, it may be possible to achieve an enhancement in melting and contraction efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A complex protection device comprising:
a substrate provided, at an upper surface thereof, with a pair of fuse terminals, first and second resistor terminals, and first and second connecting terminals to connect the first and second resistor terminals;
an insulating layer formed on the first and second connecting terminals;
a fusible element formed on the insulating layer, to be connected to the fuse terminals;
first and second printed resistors respectively connected to the first and second resistor terminals; and
a switching device for performing a control operation to cause current to flow to the first and second resistors when overvoltage is applied,
wherein the first and second printed resistors are disposed at opposite sides of the fusible element while being spaced apart from the fusible element.

2. The complex protection device according to claim 1, further comprising:
third resistor terminals provided at a lower surface of the substrate; and
a third printed resistor connected to the third resistor terminals and disposed directly under the fusible element under a condition that the substrate is interposed between the third printed resistor and the fusible element.

3. The complex protection device according to claim 2, wherein:
one of the first and second connecting terminals is provided with a contact portion to contact the fusible element;
one side of the contact portion is disposed directly under a central region of the fusible element; and
current emerging from the fusible element flows to the first and second printed resistors via the contact portion in a divided manner, and heat generated from the first and second printed resistors is transferred to the fusible element via the contact portion.

4. The complex protection device according to claim 2, further comprising:
a third connecting terminal disposed between the first and second connecting terminals, the third connecting terminal having a free end connectable to the fusible element and a fixed end connected to one of the first and second resistor terminals;
the free end of the third connecting terminal is disposed directly under a central region of the fusible element; and
current emerging from the fusible element flows to the first, second and third printed resistors via the third connecting terminal in a divided manner, and heat generated from the first, second and third printed resistors is transferred to the fusible element via the third connecting terminal.

5. The complex protection device according to claim 2, wherein facing surfaces of the fuse terminals have a semicircular or semi-oval shape.

6. The complex protection device according to claim 2, wherein the fusible element comprises a plate-shaped alloy portion, and a flux portion received in the alloy portion.

7. The complex protection device according to claim 2, wherein a protective film made of an insulating material is formed over the first, second, and third printed resistors.

8. The complex protection device according to claim 2, wherein a resistor receiving groove is formed at the lower surface of the substrate, to receive the third resistor terminals and the third printed resistor, for installation thereof.

9. The complex protection device according to claim 8, wherein a protective film is formed on the third printed resistor received in the resistor receiving groove, to bury the third printed resistor in the substrate.

10. The complex protection device according to claim 2, wherein a heat transfer hole is formed directly under the fusible element, to easily transfer heat generated from the third printed resistor to the fusible element.

11. The complex protection device according to claim 2, wherein each of the third resistor terminals is connected to a corresponding one of the first and second connecting terminals through a via hole provided directly under the fusible element.

12. The complex protection device according to claim 3, further comprising:
a melting inducing member disposed directly under the central region of the fusible element, to concentrate heat to the fusible element during heat generation of the resistors,
wherein the melting inducing member has a circular or oval shape, to allow a melt of the fusible element to contract toward a center of the melting inducing member during melting of the fusible element.

13. The complex protection device according to claim 12, wherein:
a contact portion is provided at one of the first and second connecting terminals directly under the melting inducing member; and
an insulating layer is formed between the melting inducing member and the first and second connecting terminals while centrally having a hole to connect the melting inducing member and the contact portion through soldering.

14. The complex protection device according to claim 2, wherein:
one of the first and second connecting terminals comprises the contact portion, and a pair of connecting portions each connected, at one end thereof, to the contact portion while being connected, at the other end thereof, to a corresponding one of the first and second resistor terminals;
the contact portion has a circular or oval shape while having a greater width than the connecting portions; and
an insulating layer is formed between the contact portion and the fusible element while centrally having a hole to connect the contact portion and the fusible element through soldering.
